(19) United States
(12) Patent Application Publication
(10) Pub. No.: US 2015/0286881 A1
(43) Pub. Date: Oct. 8, 2015

(54) RECORDING APPARATUS FOR RECORDING VEHICLE CONDITION AND RECORDING METHOD THEREOF

(71) Applicant: Wistron Corp., New Taipei City (TW)

(72) Inventors: Tai-Chuan CHEN, New Taipei City (TW); Yao-Tsung CHANG, New Taipei City (TW); Hong-Chi CHEN, New Taipei City (TW); Cheng-Hsin LIU, New Taipei City (TW); Shao-Lun CHAO, New Taipei City (TW)

(21) Appl. No.: 14/447,256

(22) Filed: Jul. 30, 2014

(30) Foreign Application Priority Data
Apr. 7, 2014 (TW) 103112658

(51) Int. Cl. G06K 9/00; B60R 1/00

(52) U.S. Cl. CPC G06K 9/00832; G06K 9/00288; B60R 1/00

(57) ABSTRACT

A recording apparatus set on a car for recording vehicle condition includes at least one camera arranged to photograph the car, and a controller arranged to control the at least one camera to photograph the car exterior and the car interior when an indication signal received by the controller indicates that the car is being picked up, and arranged to control the at least one camera to photograph the car exterior and the car interior when the indication signal received by the controller indicates that the car is being returned.

### CROSS REFERENCE TO RELATED APPLICATIONS

This Application claims priority of Taiwan Patent Application No. 103112658, filed on Apr. 7, 2014, the entirety of which is incorporated by reference herein.

### BACKGROUND OF THE INVENTION

1. Field of the Invention

The present invention relates to a recording apparatus and in particular to a recording apparatus set on a car for recording the car exterior and the car interior, or recording the driver.

2. Description of the Related Art

In the car rental business, there is a need for both the renter and the company representative who is supplying the car (called the “owner” hereinafter) to meet together at a particular location to visually record vehicle condition or record vehicle condition by photographing. However, this recording approach can lead to disputes between the renter and the owner. Moreover, the particular place is additionally required.

Recently, a new type of car rental, called a car-sharing service, has been developed. The car-sharing service mainly emphasizes self-service, and it is also not limited by time or place. When picking up the car, a renter visually checks the car exterior by himself; when returning the car, the owner checks the car exterior by himself. However, there is no effective way, in a car-sharing service, to check the car interior. Usually, the owner verbally asks the renter to maintain the cleanliness of the car interior. Moreover, the owner usually also sets up a device in the car for grading the car, and the next renter grades the car based on cleanliness of the car interior. Additionally, after returning the car, the owner finds out the location of the car by tracking its GPS signal, and heads to the place where the car is located to check the vehicle condition and to clean the car.

However, in the car sharing service, people are still required to check the car exterior and the car interior. For example, after the renter returns the car, the owner has to head to the place where the car is located to check the exterior and interior condition of the car. Moreover, it is hard to confirm whether the driver of the car and the renter are the same one, and this situation leads to difficulty to tell who is at fault if an accident has occurred.

Therefore, a new recording apparatus for recording vehicle is required to solve the aforementioned problems.

### BRIEF SUMMARY OF THE INVENTION

In view of this, an exemplary embodiment of the invention provides a recording apparatus for recording vehicle condition. The recording apparatus for recording vehicle condition includes at least one camera arranged to photograph the car. The recording apparatus for recording vehicle condition further includes a controller arranged to control the at least one camera to photograph the car exterior and the car interior when an indication signal received by the controller indicates that the car is being picked up, and arranged to control the at least one camera to photograph the car exterior and the car interior when the indication signal received by the controller indicates that the car is being returned.

In another exemplary embodiment of the invention, the aforementioned recording apparatus for recording vehicle condition further includes a storage device arranged to store image information output by the at least one camera. The aforementioned recording apparatus for recording vehicle condition further includes a wireless device arranged to transmit image information stored in the storage device to an external server. The aforementioned recording apparatus for recording vehicle condition further includes an image-comparison device arranged to compare image information output by the at least one camera when the car is being picked up with image information output by the at least one camera when the car is being returned.

In another exemplary embodiment of the invention, the aforementioned recording apparatus for recording vehicle condition further includes a detector controlled by the controller to detect whether a driver is in the driver's seat when the controller detects that a door-lock controller of the car is being activated. The controller further controls the at least one camera to photograph the driver when the detector detects the driver is in the driver's seat.

In an exemplary embodiment of the invention further provides a recording method for recording vehicle condition. The recording method is applied to a recording apparatus set on a car. The recording method includes photographing a car by at least one camera of the recording apparatus. The recording method further includes a controller of the recording apparatus arranged to control the at least one camera to photograph the car exterior and the car interior when an indication signal received by the controller indicates that the car is being picked up, and arranged to control the at least one camera to photograph the car exterior and the car interior when the indication signal received by the controller indicates that the car is being returned.

The owner benefits from the aforementioned recording apparatus for recording vehicle condition and the recording method for recording vehicle condition, because there is no need for the owner to head to where the car is being picked up and/or returned to check vehicle condition, and additionally the owner is able to confirm whether the renter and the driver of the car is the same person.

### BRIEF DESCRIPTION OF THE DRAWINGS

Aspects of the present disclosure are best understood from the following detailed description when read with the accompanying figures. It should be noted that, in accordance with the standard practice in the industry, various features are not drawn to scale. In fact, the dimensions of the various features may be arbitrarily increased or reduced for clarity of discussion.

FIG. 1 is a diagram illustrating a recording apparatus in accordance with an exemplary embodiment of the invention to communicate with the external server.

FIG. 2 is a flow chart illustrating an operation of the recording apparatus in accordance with an exemplary embodiment of the invention.

FIG. 3 is a flow chart illustrating another operation of the recording apparatus in accordance with an exemplary embodiment of the invention.

### DETAILED DESCRIPTION OF THE INVENTION

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

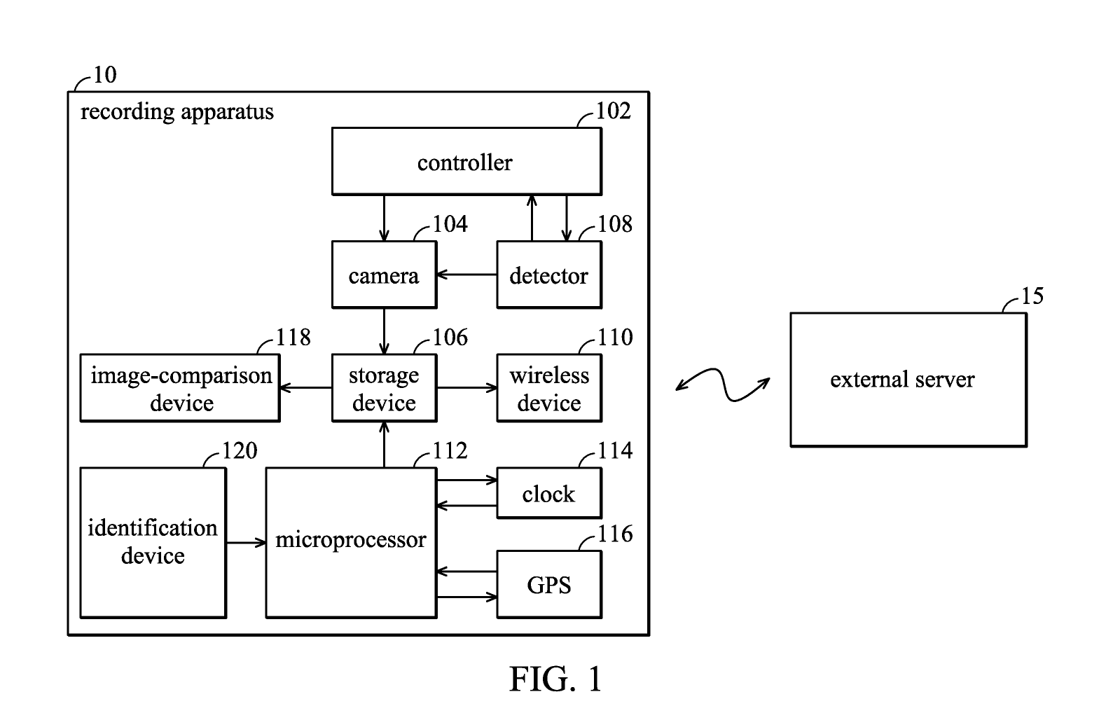

FIG. 1 is a diagram illustrating a recording apparatus in accordance with an exemplary embodiment of the invention to communicate with the external server. The recording apparatus 10 for recording vehicle condition may include a controller 102, a camera 104, a storage device 106, a detector 108, a wireless device 110, a microprocessor 112, a clock 114, a Global Positioning System (GPS) 116, an image-comparison device 118 and an identification device 120. In a specific embodiment, the recording apparatus 10 may only include the controller 102 and the camera 104. Furthermore, the recording apparatus 10 is set up on the car, and, more specifically, the recording apparatus 10 may be set up on the car body or in the car interior, but is not limited thereto. Moreover, “vehicle condition” recorded by the recording apparatus 10 may refer to the car exterior and/or the car interior.

The camera 104 is arranged to photograph the car. It should be noted that although the recording apparatus 10 shown in FIG. 1 includes only one camera, the invention is not limited thereto and the recording apparatus of the invention may include one or more than one camera wherein one camera is arranged to photograph the car exterior, and another one camera is arranged to photograph the car interior. Moreover, the camera of the invention may include a peripheral device, such as the camera flash, of the camera.

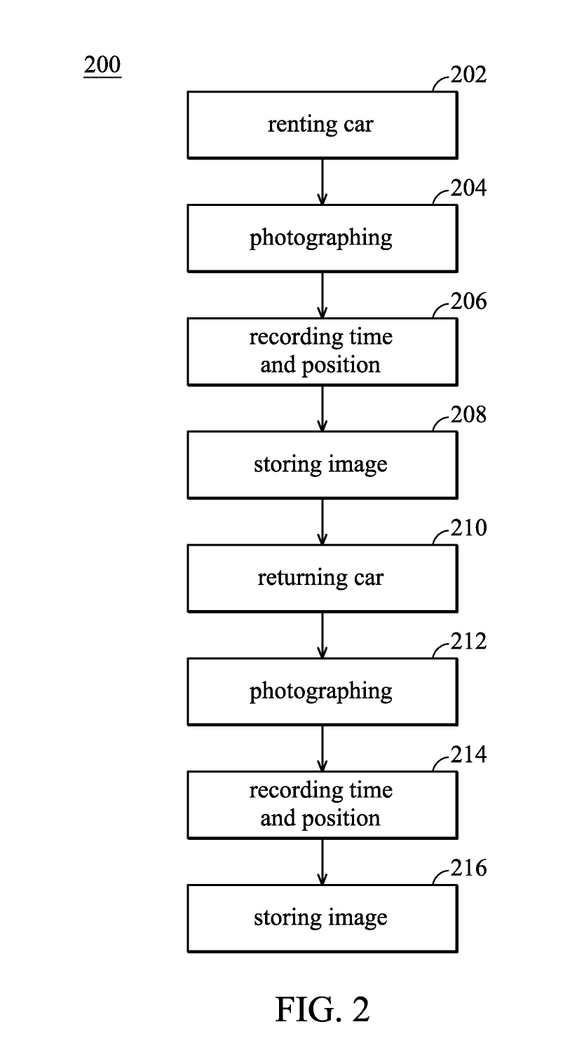

FIG. 2 is a flow chart illustrating an operation of the recording apparatus in accordance with an exemplary embodiment of the invention. An operation 200 includes steps 202-216 wherein steps 206 and 214 are optional.

In step 202, a renter rents a car. For example, the renter inputs an identification code on an identification device 120 to rent the car. After identification, the identification device 120 transmits a signal which indicates that the renter is renting the car. The approach to inputting an identification code into the identification device 120 may, for example, be via a device with a keyboard, scanning a QR code, inputting a code via a connection with a cell phone or inputting ID with RFID (Radio-Frequency Identification) technologies.

In step 204, the controller 102 is arranged to control the camera 104 to photograph the car exterior and the car interior when an indication signal received by the controller 102 indicates that the car is being picked up.

In optional step 206, the microprocessor 112 is arranged to record the time as indicated by the clock 114 and the position indicated by the GPS 116 into image information output by the camera 104 when the camera 104 photographs the car. In this way, both the renter and the owner know when and where the car is being picked up.

In step 208, after the camera 104 photographs, the camera 104 outputs image information to the storage device 106, which is arranged to store image information output by the camera 104 wherein an object taken by the camera 104 is, for example, the car exterior or the car interior, and therefore the camera 104 outputs image formation thereof. Moreover, the format of image information may be an image file or a video file.

Steps 210-216 are similar to steps 202-208. In step 210, the renter returns the car. For example, the renter inputs an identification code into an identification device 120 to return the car. After identification, the identification device 120 transmits a signal which indicates that the renter is returning the car. The approach to inputting an identification code into the identification device 120 may be, for example, inputting a code via a device with a keyboard, scanning a QR code, inputting a code via connection with a cell phone or inputting ID with RFID (Radio-Frequency Identification) technologies.

In step 212, the controller 102 is arranged to control the camera 104 to photograph the car exterior and the car interior when the indication signal received by the controller 102 indicates that the car is being returned.

In alternative step 214, the microprocessor 112 is arranged to record the time as indicated by the clock 114 and the position indicated by the GPS 116 into image information output by the camera 104 when the camera 104 photograph the car. In this way, both of the renter and the owner know when and where the car is being returned.

In step 216, after the camera 104 photographs, image information is output from the camera 104 to the storage device 106, which is arranged to store image information output by the camera 104.

The wireless device 110 is arranged to access image information stored in the storage device 106 and is arranged to transmit image information stored in the storage device 106 to an external server 15. The operation of transmitting image information by the aforementioned wireless device 110 may be performed once after each of steps 208 and 216. Moreover, the operation of transmitting image information may be performed once only after step 216, but it is not limited thereto. The wireless communication technologies adopted by the wireless device 110 may be any of Radio Frequency Identification (RFID), Near Field Communication (NFC), Bluetooth (Bluetooth®), WIFI, 3G and 4G.

The image-comparison device 118 is arranged to compare image information output by the camera 104 when the car is being picked up with image information output by the camera 104 when the car is being returned. By means of the operation of the image-comparison device 118, it is able to know whether the car exterior when the car was picked up is the same as the car exterior when the car is returned. In this way, it is able to confirm whether the car is damaged during the rental. Moreover, it is able to know whether the car is clean when the car is being returned. Furthermore, the owner is able to know whether the renter has left something in the car according to the comparison result, and if there is something left in the car, the owner can inform the renter immediately.

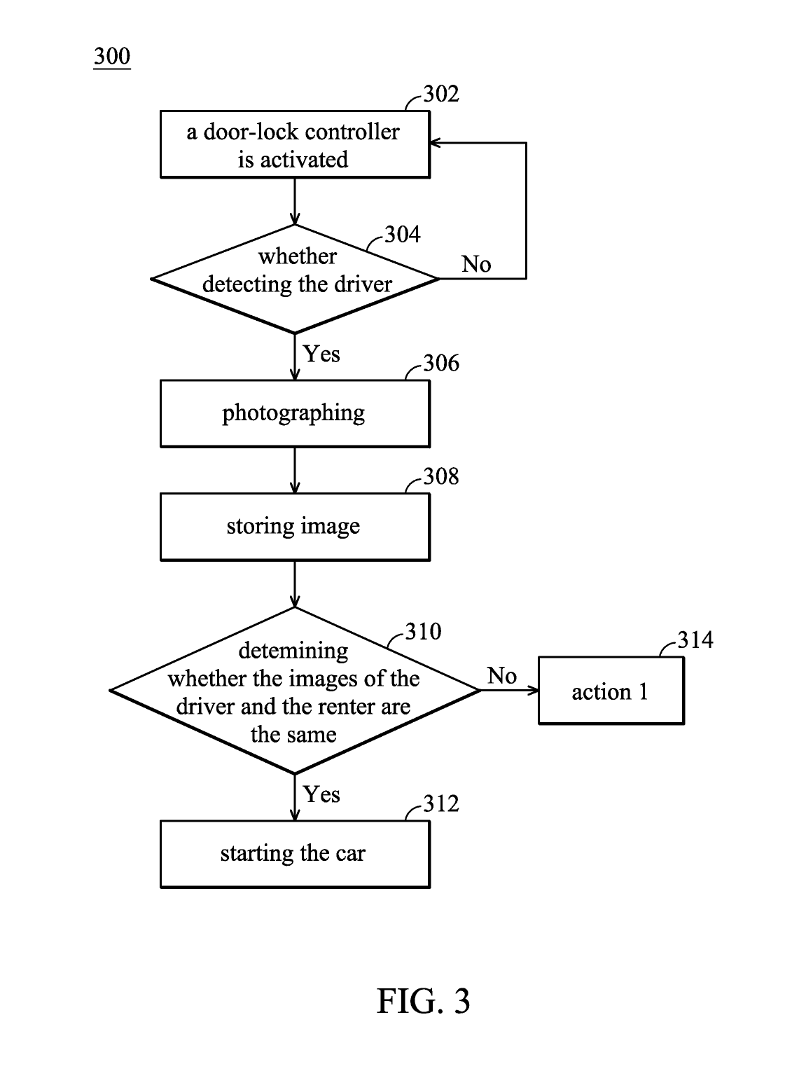

FIG. 3 is a flow chart illustrating another operation of the recording apparatus in accordance with an exemplary embodiment of the invention. After confirming that the renter rents the car, an operation 300 performed by the recording apparatus 10 includes steps 302-312.

In step 302, the controller 102 detects that the door-lock controller of the car is being activated (i.e. the door of the car is opened).

In step 304, the controller 102 controls the detector 102 to detect whether a driver is in the driver's seat when the controller 102 detects that a door-lock controller of the car is being activated. If “yes”, the operation 300 proceeds to step 306; if “no”, the operation 300 returns to step 302. The detector 108 may be any of G sensor (gravity sensor), light sensor, body temperature sensor, infrared sensor and image-identification sensor.

In step 306, the controller 102 further controls the camera 104 to photograph the driver when the detector 108 detects the driver is in the driver's seat. In step 308, the storage device 106 is arranged to store the driver's image taken by the camera 104. In a specific embodiment, the wireless device 110 is arranged to transmit the driver's image taken by the camera 104 to the external server 15 for recording a plurality of images which are taken whenever the driver gets into the car. In this way, it is able to realize that who is at fault, if the car accident is happened or the driver violates a traffic rule during car rental. Moreover, this approach mentioned above can be used as a security mechanism of the car; once the security mechanism is triggered but the car is not rented, it is extremely possible that the car is being stolen.

In step 310, an image-comparison device 118 is arranged to compare the driver's image taken by the camera 104 with a renter's image stored in the storage device 106 in advance to determine whether the two images are the same.

If “yes”, the operation 300 proceeds to step 312. In step 312, the recording apparatus 10 may transmit a signal to allow a starter of the car staring the car. The above operation is only used as an example, and the invention is not limited thereto.

If “no”, proceeding to step 314. In step 314, the recording apparatus 10 performs an action 1 wherein the action 1 may be a situation, for example, in which the recording apparatus 10 transmits a disable signal to the starter of the car to disable the starter from starting the car. The action 1 may also be a situation in which the wireless device 110 transmits a signal to inform the external server 15 that the driver and the renter are not the same person. The action 1 may also be a situation in which the recording apparatus 10 makes the car emit an alarm. Every practice described above is used as an example, and the invention is not limited thereto. Based on the above description, step 310 may be used to avoid a situation in which the identity document of the driver is being used illegally by another person.

Various operations of embodiments are provided herein. The order in which some or all of the operations are described should not be construed as to imply that these operations are necessarily order-dependent. Alternative ordering will be appreciated given the benefit of this description. Further, it should be understood that not all operations are necessarily present in each embodiment provided herein. Also, it should be understood that not all operations are necessary in some embodiments.

Moreover, “exemplary” is used herein to mean serving as an example, instance, illustration, etc., and not necessarily as advantageous. As used in this application, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B or the like generally means A or B or both A and B. Furthermore, to the extent that “includes”, “having”, “has”, “with”, or variants thereof are used, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims.

What is claimed is:

1. A recording apparatus set on a car for recording vehicle condition, the recording apparatus comprising:
at least one camera, arranged to photograph the car;
a controller, arranged to control the at least one camera to photograph the car exterior and the car interior when an indication signal received by the controller indicates that the car is being picked up, and arranged to control the at least one camera to photograph the car exterior and the car interior when the indication signal received by the controller indicates that the car is being returned.

2. The recording apparatus as claimed in claim 1, further comprising:
a storage device, arranged to store image information output by the at least one camera;
a wireless device, arranged to transmit image information stored in the storage device to an external server; and
an image-comparison device, arranged to compare image information output by the at least one camera when the car is being picked up with image information output by the at least one camera when the car is being returned.

3. The recording apparatus as claimed in claim 2, further comprising:
a clock;
a GPS (Global Positioning System); and
a microprocessor, arranged to record time as indicated by the clock and a position indicated by the GPS into image information output by the at least one camera when the at least one camera photograph the car.

4. The recording apparatus as claimed in claim 1, further comprising:
a detector, controlled by the controller to detect whether a driver is in the driver's seat when the controller detects that a door-lock controller of the car is being activated; the controller further controls the at least one camera to photograph the driver when the detector detects that the driver is in the driver's seat.

5. The recording apparatus as claimed in claim 4, further comprising:
a storage device, arranged to store an image of the driver taken by the at least one camera;
an image-comparison device, arranged to compare the driver's image taken by least the camera with a renter's image stored in the storage device in advance.

6. The recording apparatus as claimed in claim 4, wherein the recording apparatus transmits a disable signal to a starter of the car to disable the starter from starting the car when the image-comparison device distinguishes the driver's image from the renter's image.

7. A recording method for recording vehicle condition applied to a recording apparatus set on a car, the recording method comprising:
photographing a car by at least one camera of the recording apparatus;
wherein a controller of the recording apparatus is arranged to control the at least one camera to photograph the car exterior and the car interior when an indication signal received by the controller indicates that the car is being picked up, and arranged to control the at least one camera to photograph the car exterior and the car interior when the indication signal received by the controller indicates that the car is being returned.

8. The recording method as claimed in claim 7, further comprising:
performing, by a microprocessor:
recording time told by the clock and a position indicated by the GPS into image information output by the at least one camera when the at least one camera photograph the car.

9. The recording method as claimed in claim 7, further comprising:
controlling a detector to detect whether a driver is in the driver's seat by the controller when the controller detects that a door-lock controller of the car is being activated; further controlling the at least one camera to photograph the driver by the controller when the detector detects the driver is in the driver's seat.

10. The recording method as claimed in claim 9, further comprising:
storing an image of the driver taken by the at least one camera in a storage device of the recording apparatus; and
comparing the driver's image taken by least the camera with a renter's image stored in the storage device in advance with an image-comparison device of the recording apparatus.

11. The recording method as claimed in claim 10, further comprising:
transmitting a disable signal from the recording apparatus to a starter of the car to disable the starter from starting the car when the image-comparison device distinguishes the driver's image from the renter's image.
